(19) United States
(12) Patent Application Publication
(10) Pub. No.: US 2025/0187924 A1
(43) Pub. Date: Jun. 12, 2025

(54) PRODUCTION OF HIGH-QUALITY GRAPHENE FROM SOLID CARBON SOURCES

(71) Applicant: Jacob Grant SIEGAL, Weston, MA (US)

(72) Inventor: Jacob Grant SIEGAL, Weston, MA (US)

(21) Appl. No.: 18/845,949

(22) PCT Filed: Mar. 10, 2023
(86) PCT No.: PCT/US2023/064083

§ 371 Date: Sep. 11, 2024

Related U.S. Application Data
(60) Provisional application No. 63/319,039, filed on Mar. 11, 2022.

(51) Int. Cl. C01B 32/184; C01B 32/205; C01B 32/225

(52) U.S. Cl. CPC C01B 32/184; C01B 32/205; C01B 32/225; C01B 2204/22; C01B 2204/30; C01B 2204/32; C01P 2006/12; C01P 2006/40; C01P 2006/80

(57) ABSTRACT

This invention relates generally to systems and methods for the production of high-quality graphene from solid carbon sources.

### BACKGROUND OF THE INVENTION

Graphene is one of the most promising materials in nanotechnology. The mechanical, thermal, and electrical properties of graphene samples with high perfection of the atomic lattice are exceptional, but structural defects, which may appear during growth or processing, deteriorate the performance of graphene-based devices. What is needed in the field is improved methods of producing high-quality graphene.

### SUMMARY OF THE INVENTION

The present invention is related to methods of producing and using high-purity graphene.

In one embodiment, the present invention provides methods of producing graphene, the method including: a) providing a high-purity solid carbon source; and b) applying a voltage pulse across the solid carbon source to convert the solid carbon source into graphene.

In one embodiment, the present invention provides methods of producing graphene, the method including: a) providing a high-purity solid carbon source, wherein the solid carbon source is greater than 99.99% (w/w) elemental carbon; and b) applying a voltage pulse across the solid carbon source to convert the solid carbon source into graphene, wherein the graphene includes less than 200 ppm extrinsic defects.

In some embodiments, the solid carbon source is greater than 99.995% (w/w) elemental carbon. In some embodiments, the solid carbon source is greater than 99.999% (w/w) elemental carbon. In some embodiments, the solid carbon source is greater than 99.9995% (w/w) elemental carbon. In some embodiments, the solid carbon source is greater than 99.9999% (w/w) elemental carbon.

In some embodiments, the graphene includes less than 100 ppm extrinsic defects. In some embodiments, the graphene includes less than 50 ppm extrinsic defects. In some embodiments, the graphene includes less than 25 ppm extrinsic defects. In some embodiments, the graphene includes less than 10 ppm extrinsic defects. In some embodiments, the graphene includes less than 5 ppm extrinsic defects. In some embodiments, the graphene includes less than 1 ppm extrinsic defects.

In some embodiments, the extrinsic defects are assessed by Raman spectroscopy, x-ray photoelectron spectroscopy (XPS), inductively coupled plasma optical emission spectroscopy (ICP-OES), ICP-mass spectroscopy (ICP-MS), proton induced x-ray emission, x-ray diffraction (XRD), transmission electron microscopy (TEM), scanning electron microscopy (SEM), scanning tunnelling microscopy (STM), atomic force microscopy (AFM), energy dispersive x-ray analysis (EDX), oxidative combustion, and/or thermo gravimetric analysis.

In some embodiments, the extrinsic defect is oxygen. In some embodiments, the graphene includes less than 200 ppm oxygen.

In some embodiments, the graphene includes less than 0.01% intrinsic defects. In some embodiments, the intrinsic defects include non-sp² orbital hybrid carbon atoms. In some embodiments, the graphene includes less than 0.01% sp³. In some embodiments, percent sp² of the graphene is at least 95%.

In some embodiments, the graphene has a I(D)/I(G) ratio of less than 0.2, as measured by Raman spectroscopy. In some embodiments, the graphene has a I(2D)/I(G) ratio of between 0.5 and 2, as measured by Raman spectroscopy.

In some embodiments, the electrical conductivity of the graphene is at least 104 S/m. In some embodiments, the specific surface area (SSA) of the graphene is greater than 1000 m²/g. In some embodiments, the graphene is graphene flakes, and wherein the graphene flakes have an average lateral size (D50) of at least 10 μm.

In some embodiments, the graphene is not purified following step b). In some embodiments, extrinsic defects are not removed following step b). In some embodiments, the method further includes the step of c) mixing the graphene with a binding agent or dispersing agent without further purification.

In some embodiments, the solid carbon source includes greater than 90% (w/w) amorphous carbon. In some embodiments, the solid carbon source includes greater than 90% (w/w) graphite carbon.

In some embodiments, the solid carbon source is generated by reduction of carbon dioxide or carbon monoxide with hydrogen gas. In some embodiments, the solid carbon source is produced from carbon dioxide and hydrogen gas via a Bosch reaction. In some embodiments, the hydrogen gas is provided an amount greater than the stoichiometric ratio required for a reduction of the carbon dioxide or carbon monoxide. In some embodiments, the solid carbon source is produced from carbon monoxide via a Boudouard reaction. In some embodiments, the reaction includes a catalyst or catalyst pre-cursor. In some embodiments, the reaction occurs at room temperature. In some embodiments, the reaction occurs at temperatures between 450°° C. to 2000° C. In some embodiments, step b) is conducted under atmospheric pressure.

In some embodiments, the method produces at least one gram of graphene. In some embodiments, the yield of graphene from the solid carbon source is at least 90%.

The invention further features a device including a combination of: (a) a first component for providing a high-purity solid carbon source by reduction of carbon dioxide or carbon monoxide with hydrogen gas; and (b) a second component for applying a voltage pulse across the solid carbon to convert the solid carbon into graphene.

### Definitions

To facilitate the understanding of this invention, a number of terms are defined below and throughout the disclosure. Unless otherwise defined, all technical and scientific terms used herein have the same meaning as commonly understood by one of ordinary skill in the art to which this invention belongs. The terminology herein is used to describe specific embodiments of the invention, but their usage does not limit the invention, except as outlined in the claims.

Terms such as “a”, “an,” and “the” are not intended to refer to only a singular entity but include the general class of which a specific example may be used for illustration.

As used herein, the term “about” refers to a value that is within 10% above or below the value being described.

As used herein, the term “amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

As used herein, the term “defect” refers to physical anomalies in a material as compared to that ideal material, for example, defects are physical differences between prepared graphene and ideal graphene.

As used herein, the term “intrinsic defect” refers to imperfections in a material due to carbon bonding. For example, intrinsic defects are described in: Tian et al., Micromachines vol. 8,5 163 (2017), herein incorporated by reference.

As used herein, the term “extrinsic defect” refers to imperfections in a material due to the presence of foreign atoms, such as a non-carbon atom in graphene. For example, extrinsic defects are described in: Tian et al., Micromachines vol. 8,5 163 (2017).

As used herein, the term “sp² hybridization” refers to carbon atoms directly bound to three other carbon atoms and having a planar geometry. For example, sp² hybridization with regards to graphene is described in: Kovtun et al., 2D Mater. 6, (2019).

As used herein, the term “sp³ hybridization” refers to carbon atoms bound to four other atoms and having a tetrahedral geometry. For example, sp³ hybridization with regards to graphene is described in:

Kovtun et al., 2D Mater. 6, (2019).

### BRIEF DESCRIPTION OF DRAWINGS

The following detailed description of the embodiments of the invention will be better understood when read in conjunction with the appended drawings. For the purpose of illustrating the invention, there are shown in the drawing embodiments, which are presently exemplified. It should be understood, however, that the invention is not limited to the precise arrangement and instrumentalities of the embodiments shown in the drawings.

FIGS. 1A, 1B, and 1C show an embodiment of a chamber for the production of solid carbon and/or graphene.

FIGS. 2A, and 2B show an embodiment of a catalyst.

FIG. 3 shows an embodiment of a gasket.

### DETAILED DESCRIPTION OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, and/or components have not been described in detail in order to avoid unnecessarily obscuring claimed subject matter. The illustrative embodiments described in the detailed description and claims are not meant to be limiting. Other embodiments may be utilized, and other changes may be made, without departing from the spirit or scope of the subject matter presented here. It will be readily understood that the aspects of the present disclosure, as generally described herein, can be arranged, substituted, combined, and designed in a wide variety of different configurations, all of which are explicitly contemplated and make part of this disclosure.

Without limiting the scope of the invention, the present invention is related to the production of high-purity graphene. In particular, the present disclosure provides a method for the efficient, industrial scale production of graphene from high-purity solid carbon sources.

### Graphene and Graphene Defects

Graphene is a two-dimensional honeycomb-structured material formed by a single layer of sp² hybrid orbital carbon atoms. A single layer of ideal graphene has a thickness of about 0.335 nm, corresponding to the thickness of one carbon atom. Graphene, having a two-dimensional crystal structure, has many advantageous features such as a high specific surface area, and advantageous electrical, thermal and mechanical properties. For example, graphene has exceptional mechanical properties due the stability of the sp² bonds that form the hexagonal lattice and oppose a variety of in-plane deformations.

Potential applications of graphene include use in composite materials (e.g., as a reinforcing or thermal agent), field effect transistors, electromechanical systems, strain sensors, electronics, batteries, supercapacitors, in micro-nano devices, hydrogen storage and solar cells. Applications for graphene expand with the rise in availability of low-cost, high-quality graphene.

However, prior methods for the production of graphene are prone to defects. In most cases, these defects can affect the mechanical properties as well as the thermal and electrical conductivities of graphene and graphene-based composites. Defects in graphene may be categorized into two different groups: intrinsic and extrinsic defects.

Intrinsic defects may be composed of non-sp² orbital hybrid carbon atoms in graphene. Intrinsic defects in graphene may result in layers of graphene being adhered together. Ideal graphene, free of defects, will have no chemically bonded carbon atoms between layers. However, if there are intrinsic defects (e.g., holes, dangling bonds, or carbon atoms in the migrating state) in the graphene, the defective graphene layers may form new chemical bonds with adjacent carbon atoms in other graphene layers.

Extrinsic defects are defined by the crystalline order of graphene being perturbed with foreign, or non-carbon atoms. The foreign atoms may be substitutional (replacing original lattice atoms) or interstitial. In prior methods, the foreign atoms are most often oxygen atoms or oxygen-containing functional groups such as a hydroxyl groups or a carboxyl groups. In fact, oxygen atoms in graphene are difficult to completely remove during subsequent reduction processes, and thus the best method of producing graphene with low levels of oxygen-related defects is to prevent the contamination during synthesis of the graphene itself, as is taught herein.

Defects may affect the mechanical, electrical, and thermal characteristics of graphene. For example, while ideal graphene has a thermal conductivity of about 5000 W/m·K, defects may change the thermal conductivity. It has been previously found that a point defect or a single vacancy defect in the graphene may lower the thermal conductivity to 20% of the former figure. When the defect concentration further increases, the thermal conductivity may further lower.

A variety of techniques may be used to assess graphene, including Raman spectroscopy, x-ray photoelectron spectroscopy (XPS), inductively coupled plasma optical emission spectroscopy (ICP-OES), ICP-mass spectroscopy (ICP-MS), proton induced x-ray emission, x-ray diffraction (XRD), transmission electron microscopy (TEM), scanning electron microscopy (SEM), scanning tunnelling microscopy (STM), atomic force microscopy (AFM), energy dispersive x-ray analysis (EDX), oxidative combustion, and/or thermo gravimetric analysis.

In some embodiments, Raman spectroscopy is used to characterize the graphene. Raman spectroscopy may be used to assess the electronic structure and in identifying the two-dimensional nature of the graphene. In particular, the D peak in the Raman spectrum of graphene is not present in ideal graphene, however, increases in intensity as the number of defects increases. The D peak is sensitive to disruption of the symmetry of the graphene honeycomb lattice, such as grain boundaries, vacancies, edges, carbon atoms with sp³ hybridization, etc. The G peak, meanwhile, is sensitive to the number of layers present in the graphene. In some embodiments, the ratio between the intensities of the D and G peaks I(D)/I(G) is used estimate the levels of defects in the graphene. However, as disorder in graphene increases, I(D)/I(G) displays two different behaviors. There is a regime of “low” defect density where I(D)/I(G) will increase with higher defect. This phenomena occurs up to a regime of “high” defect density, at which point I(D)/I(G) will begin to decrease as an increasing defect density results in a more amorphous carbon structure, attenuating all Raman peaks. Furthermore, single layer graphene can also be identified by analyzing the peak intensity ratio of the 2D and G bands. For example, the I(2D)/I(G) ratio for defect free single layer graphene is equal to 2.

The oxygen content of graphene may be characterized by photoelectron spectroscopy. UV-Vis spectroscopy is also useful for the chemical analysis of graphene dispersions in different solvents as it enables monitoring of the reaction process by using Beer's law and the linear relationship between the absorbance and concentration of the solution. Moreover, XRD can be applied for the evaluation of the exfoliation and intercalation of graphite and the ultimate formation of graphene. The characteristic Bragg peak of graphite at 2 θ=26° broadens with decreasing number of layers, and it ultimately disappears for monolayer graphene. Scherrer's formula can be also used for a relative estimation of the number of layers from an X-ray diffractogram. XPS may be applied for the characterization of the surface chemical structure of graphene, by yielding the binding energy between the carbon-carbon and carbon-oxygen bonds in the material. The surface area of the graphene may be measured by the Brunauer-Emmett-Teller (BET) method.

Various forms of microscopy may be used to evaluate graphene, and the extent of defects, or lack thereof. TEM may be used to characterize the atomic structure of graphene, such quantifying intrinsic defects in the graphene, including vacancy defects, bond rotations, dislocation edges, grain boundaries, as well as visualize layer stacking. SEM may be used to observe surface morphology of graphene. STM may provide information about the morphology and the electronic properties of graphene in three dimensions. AFM may be used to characterize the number of layers of the graphene.

### Production of High-Purity Solid Carbon Sources

The present invention produces graphene from high-purity solid carbon sources.

In some embodiments, the solid carbon sources are produced from carbon oxides, including carbon monoxide (CO) and carbon dioxide (CO₂). The carbon oxides may be reduced to form solid carbon, in some embodiments with a reducing gas, such as hydrogen gas. U.S. Pat. No. 8,679,444, herein incorporated by reference, describes a variety of methods of producing solid carbon through the reduction of carbon oxides.

There is a spectrum of reactions including carbon, hydrogen, and oxygen that may produce solid carbon. Hydrocarbon pyrolysis is the range of equilibria between hydrogen and carbon that favors solid carbon production, typically with little or no oxygen present. The Boudouard reaction, also called the carbon monoxide disproportionation reaction, is the range of equilibria between carbon and oxygen that favors solid carbon production, typically with little or no hydrogen present. The Bosch reaction is the region of equilibria where all of carbon, oxygen, and hydrogen are present that favors solid carbon production. Other equilibria favor the production of carbon oxides or hydrocarbons (e.g. the Sabatier and the Fischer-Tropsch processes) with no solid carbon product.

The Bosch reaction (CO₂+2H₂ [symbol] C+2H₂O) reduces carbon dioxide with hydrogen to produce solid carbon and water. The temperatures for the Bosch reaction may range from 400° C. to over 2000° C. In some embodiments, reaction rates may be enhanced and reaction temperatures reduced by the use of a catalyst. In some embodiments, the solid carbon source is formed through the Bosch reaction. In some embodiments, solid carbon formed through the Bosch reaction is used to produce graphene.

The Boudouard reaction (2CO [symbol] C+CO₂), also called the carbon monoxide disproportionation reaction, reduces carbon monoxide to produce solid carbon and carbon dioxide. In some embodiments, the solid carbon source is formed through the Boudouard reaction. In some embodiments, solid carbon formed through the Boudouard reaction is used to produce graphene.

The type, purity, and homogeneity of the solid carbon source may be controlled by the reaction conditions (time, temperature, pressure, partial pressure of reactants), and, in some embodiments, the catalyst (including the size, method of formation, and form of the catalyst).

In some embodiments, the temperatures for the production of solid carbon sources may range from 400° C. to 2000° C., e.g., from 400° C. to 700° C., from 400° C. to 800° C., from 400° C. to 900° C., from 400°° C. to 1000° C., from 400° C. to 1200° C., from 400° C. to 1400° C., from 400° C. to 900° C., from 500° C. to 600° C., from 500°° C. to 700° C., from 500° C. to 800° C., from 550° C. to 650° C., from 550° C. to 750° C., from 575° C. to 625° C., from 600°° C. to 650° C., from 600° C. to 700° C., from 600° C. to 800° C., from 625° C. to 675° C., from 650° C. to 700° C., from 700° C. to 1200° C., from 700° C. to 1400° C., from 800° C. to 1200° C., from 800°° C. to 1400°° C., from 900°° C. to 1400° C., from 1000° C. to 1400° C., from 1100° C. to 1400° C., from 1200°° C. to 1400° C., from 1300° C. to 1400° C., from 1000° C. to 2000° C., or from 1400° C. to 2000° C.

In some embodiments, the solid carbon source is produced under pressure. In some embodiments, the pressure for the production of solid carbon may range from 1 bar to 10 bar, e.g., from 1bar to 2 bar, from 1 bar to 3 bar, from 1 bar to 4 bar, from 1 bar to 5 bar, from 1 bar to 6 bar, from 1 bar to 7 bar, from 1 bar to 8 bar, from 1 bar to 9 bar, from 2 bar to 3 bar, from 2 bar to 4 bar, from 2 bar to 5 bar, from 2 bar to 6 bar, from 2 bar to 7 bar, from 2 bar to 8 bar, from 2 bar to 9 bar, 2 bar to 10 bar, from 3 bar to 4 bar, from 3 bar to 5 bar, from 3 bar to 6 bar, from 3 bar to 7 bar, from 3 bar to 8 bar, from 3 bar to 9 bar, from 3 bar to 10 bar, from 4 bar to 5 bar, from 4 bar to 6 bar, from 4 bar to 7 bar, from 4 bar to 7 bar, from 4 bar to 8 bar, from 4 bar to 9 bar, from 4 bar to 10 bar, from 5 bar to 6 bar, from 5 bar to 7 bar, from 5 bar to 8 bar, from 5 bar to 9 bar, from 5 bar to 10 bar, from 6 bar to 7 bar, from 6 bar to 8 bar, from 6 bar to 9 bar, from 6 bar to 10 bar, from 7 bar to 8 bar, from 7 bar to 9 bar, from 7 bar to 10 bar, from 8 bar to 9 bar, from 8 bar to 10 bar, or from 9 bar to 10 bar. In some embodiments, the solid carbon source is produced under atmospheric pressures. In some embodiments, the solid carbon source is produced under vacuum.

The use of an inert gas during the production of the solid carbon source is beneficial in that it limits the introduction of foreign atoms, such as those found in atmospheric air, into the system. In some embodiments, the solid carbon source is produced under an inert gas. In some embodiments, the inert gas is a noble gas. In some embodiments, the noble gas is argon or helium.

In some embodiments, the reactions include a catalyst. The reaction kinetics favorable to the formation of the desired species of solid carbon may be established by including a suitable catalyst. For example, the reaction may be accelerated and made to operate at a lower temperature in the presence of a catalyst. In some embodiments, for example with the use of a catalyst, the reaction may proceed to completion in under 5 seconds (e.g., in under 4 seconds, 3 seconds, 2 seconds, 1 second, or 0.5 seconds). In some embodiments, the catalyst is iron. In some embodiments, the catalyst includes coating, a sheet, a lattice structure, a honeycomb structure, etc. In some embodiments, the catalyst includes a repeating honeycomb. A lattice or honeycomb structured catalyst is advantageous in that the unique structure may increase the surface area of the catalyst, while also maintaining the strength of the catalyst.

The solid carbon source may be in the form of graphite, graphene, carbon black, amorphous carbon, fibrous carbon, Buckminster fullerenes (e.g., buckyballs, single walled carbon nanotubes, and multi-wall carbon nanotubes), etc. In some embodiments, the solid carbon source includes greater than 90% (w/w) amorphous carbon, e.g., greater than 91%, 92%, 93%, 94%, 95%, 96%, 97%, 98%, 99%, 99.5%, 99.9%, 99.95, or 99.99% (w/w) amorphous carbon. In some embodiments, the solid carbon source includes greater than 90% (w/w) graphite carbon, e.g., greater than 91%, 92%, 93%, 94%, 95%, 96%, 97%, 98%, 99%, 99.5%, 99.9%, 99.95, or 99.99% (w/w) graphite carbon.

The resulting solid carbon sources are high in purity. The present methods are advantageous in that the graphene produced includes substantially few defects due to high-purity of the solid carbon source. In some embodiments, the solid carbon source is greater than 99.99% (w/w) elemental carbon (e.g., greater than 99.995% (w/w), greater than 99.999% (w/w), greater than 99.9995% (w/w), or greater than 99.9999% (w/w) elemental carbon).

### Production of High-Quality Graphene

The present invention relates to the synthesis of graphene through flash joule heating (FJH) of high-purity solid carbon sources and is advantageous in that the resulting graphene includes very few defects as compared to prior methods. In FJH a voltage pulse is applied across a solid carbon source, rapidly heating it to produce graphene. FJH is described in U.S. Patent Publication No. US20210206642A1, which is herein incorporated by reference.

The present methods rapidly produce graphene from high-purity solid carbon sources. In some embodiments, the duration of the voltage pulse may be in under 5 seconds (e.g., in under 4 seconds, 3 seconds, 2 seconds, 1 second, 500 milliseconds, 400 milliseconds, 300 milliseconds, 200 milliseconds, 100 milliseconds, 10 milliseconds, 1 millisecond, 500 microseconds, 100 microseconds, 10 microseconds). The voltage across the sample may be between 1 V/cm and 4000 V/cm. The step of applying a voltage pulse across the material to form the graphene can include a number of voltage pulses applied across the material. In some embodiments, number of voltage pulses can be in a range between 1 pulse and 100 pulses.

The present methods of producing graphene are advantageous in that they can produce bulk quantities of high-quality or high-purity graphene, for which there is a need in both industry and academia, as well as to propel graphene into further commercial applications. Presently produced bulk graphene is known to be highly prone to defects, negatively affecting the mechanical, thermal, and electrical properties of the graphene. In some embodiments, the present methods are scaled produce at least one gram of graphene (e.g., at least 2 grams, 3 grams, 4 grams, 5 grams, 6 grams, 7 grams, 8 grams, 9 grams, 10 grams, 20 grams, 25 grams, 30 grams, 40 grams, 50 grams, 75 grams, 100 grams, 150 grams, 200 grams, 250 grams, 300 grams, 400 grams, 500 grams, 750 grams, 1 kilogram, or more) per hour or per day.

The present methods of producing graphene are also advantageous in that they have produce a high yield of graphene from the solid carbon source. In some embodiments, the yield of graphene from the solid carbon source is at least 90% (w/w) (e.g., at least 91%, at least 92%, at least 93%, at least 94%, at least 95%, at least 96%, at least 97%, at least 98%, at least 99%, at least 99.5%, at least 99.9%, at least 99.95%, at least 99.99%, at least 99.995%, at least 99.999%, at least 99.9995%, or at least 99.9999%).

In some embodiments, the graphene has properties near those of ideal graphene due to the lack of extrinsic and/or intrinsic defects.

In some embodiments, the graphene has an electrical conductivity of at least 104 S/m (e.g., at least 1.5×10⁴ S/m, at least 2×10⁴ S/m, at least 2.5×10⁴ S/m, at least 3×10⁴ S/m, at least 3.5×10⁴ S/m, at least 4×10⁴ S/m, at least 4.5×10⁴ S/m, at least 5×10⁴ S/m, at least 5.5×10⁴ S/m, at least 6×10⁴ S/m, at least 6.5×10⁴ S/m, at least 7×10⁴ S/m, at least 7.5×10⁴ S/m, at least 8×10⁴ S/m, at least 8.5×10⁴ S/m, at least 1.5×10⁴ S/m, at least 9×10⁴ S/m, or at least 9.5×10⁴ S/m). In some embodiments, the electrical conductivity of the graphene is measured by conductive atomic force microscopy (C-AFM).

In some embodiments, the graphene has a specific surface area (SSA) greater than 1000 m²/g (e.g., greater than 1100 m²/g, greater than 1200 m²/g, greater than 1300 m²/g, greater than 1400 m²/g, greater than 1500 m²/g, greater than 1600 m²/g, greater than 1700 m²/g, greater than 1800 m²/g, greater than 1900 m²/g, greater than 2000 m²/g, greater than 2100 m²/g, greater than 2200 m²/g, greater than 2300 m²/g, greater than 2400 m²/g, or greater than 2500 m²/g). In some embodiments, the SSA of the graphene is measured by the Brunauer-Emmett-Teller (BET) model.

In some embodiments, the graphene is graphene flakes, and the graphene flakes have an average lateral size (D50) of at least 10 μm (e.g., at least 50 μm, at least 100 μm, at least 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, at least 800 μm, at least 850 μm, at least 900 μm, at least 950 μm, or at least 1 mm). In some embodiments, the average lateral size of the graphene flakes is measured by static light scattering.

In some embodiments, the graphene includes less than 200 ppm extrinsic defects (e.g., less than 100, 75, 50, 25, 10, 5, or 1 ppm extrinsic defects). A common extrinsic defect in the production of graphene is contaminant oxygen. In some embodiments, the graphene includes less than 200 ppm oxygen (e.g., less than 100, 75, 50, 25, 10, 5, or 1 ppm oxygen). The level of extrinsic defects may be determined by Raman spectroscopy.

The present methods minimize intrinsic, as well as extrinsic, defects. In some embodiments, the graphene includes less than 0.01% intrinsic defects (e.g., less than 0.005%, 0.001%, 0.0005%, or 0.0001% intrinsic defects). Intrinsic defects include sp³, as opposed to standard sp², hybridized carbon atoms. In some embodiments, the graphene includes greater than 90% sp²-hybridized carbon atoms (e.g., greater than 95%, 96%, 97%, 98%, 99%, 99.9%, 99.95%, 99.99%, 99.995%, 99.999%, 99.9995%, or 99.9999% sp²-hybridized carbon atoms). In some embodiments, the graphene includes less than 10% sp³-hybridized carbon atoms (e.g., less than 5%, 4%, 3%, 2%, 1%, 0.5%, 0.1%, 0.05%, 0.01%, 0.005%, 0.001%, 0.0005%, or 0.0001% sp3-hybridized carbon atoms). The carbon hybridization may be determined via x-ray photoelectron spectroscopy (XPS) or Raman spectroscopy.

In some embodiments, the graphene includes a plurality of graphene sheets. Raman spectroscopy or ellipsometry may be used for the evaluation of the number of layers. Due to the lack of extrinsic defects, the graphene sheets remain unattached and retain their 2-D properties when stacked, such as a low I(D)/(G) ratio, as determined by Raman spectroscopy. In some embodiments, the graphene has a I(D)/I(G) ratio of less than 0.2 (e.g., less than 0.19, 0.18, 0.17, 0.16, 0.15, 0.14, 0.13, 0.12, 0.11, 0.10, 0.09, 0.08. 0.07, 0.06. 0.05, 0.04, 0.03, 0.02, 0.01, 0.005, 0.001, 0.0005, 0.0001, 0.00005, or 0.00001). In some embodiments, the graphene has a I(2D)/I(G) ratio in the range of 0.5 and 2 (e.g., between 0.6 and 2, between 0.7 and 2, between 0.8 and 2, between 0.9 and 2, between 1 and 2, between 1.1 and 2, between 1.2 and 2, between 1.3 and 2, between 1.4 and 2, between 1.5 and 2, between 1.6 and 2, between 1.7 and 2, between 1.8 and 2, or between 1.9 and 2).

In one embodiment, the present invention provides methods of producing graphene, wherein a solid carbon source is generated in a first chamber, the solid carbon source is transferred to a second chamber, wherein the second chamber includes a plurality of electrodes, and a voltage pulse is applied across the solid carbon source to convert the solid carbon source into graphene. However, in some embodiments, the solid carbon source and graphene may be produced in the same chamber. In one embodiment, the present invention provides methods of producing graphene, wherein a solid carbon source is generated in a chamber, wherein the chamber includes a plurality of electrodes, and the plurality of electrodes apply a voltage pulse across the solid carbon source to convert the solid carbon source into graphene. A closed system, such as two interconnected chambers, or a single chamber, may be advantageous in that it minimizes the risk of exposing the system to foreign matter, such as atmospheric air.

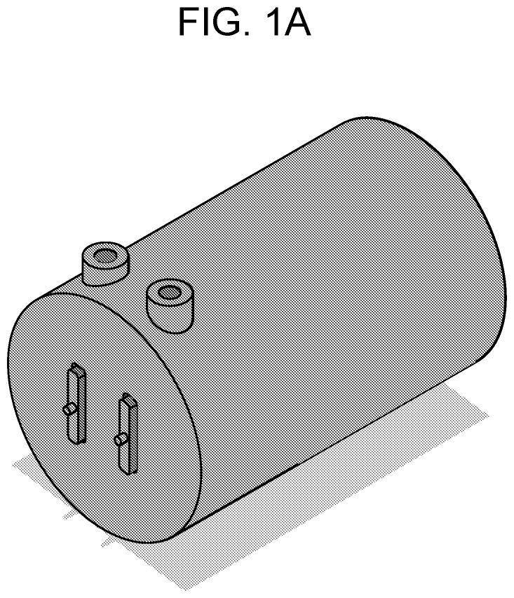

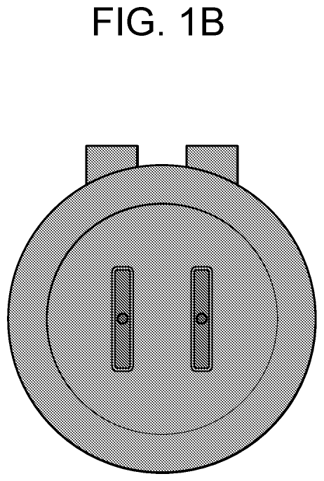

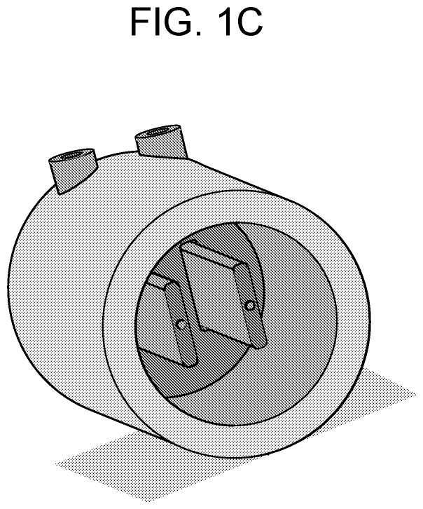

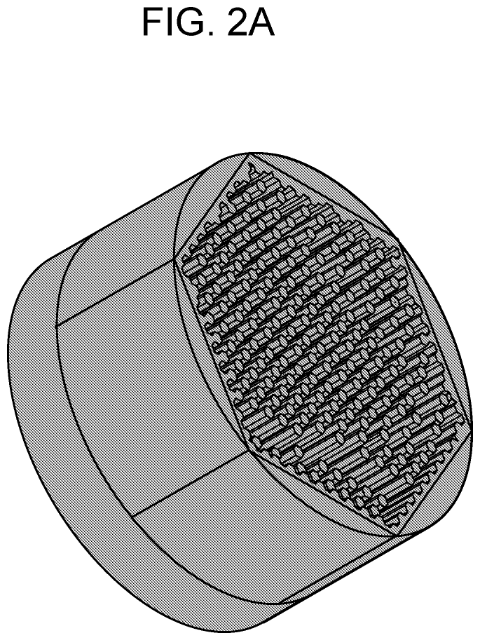

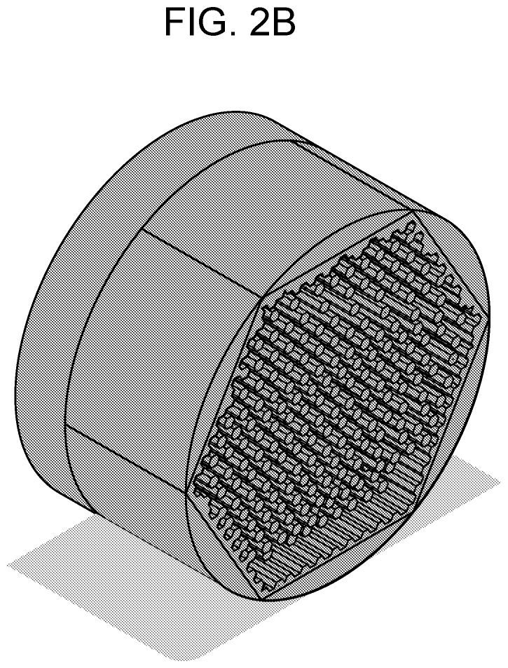

FIGS. 1A, 1B, and 1C depict one embodiment of a chamber. In some embodiments, the chamber is non-conductive and/or nonreactive. In some embodiments, the chamber is resistant to high heat and pressure, e.g., temperatures over 700° C. and pressures over 200 PSI. In some embodiments, the chamber includes Monel K500. FIGS. 2A and 2B depict a catalyst for use with the chamber of FIGS. 1A, 1B, and 1C. The catalyst may be iron.

The electrodes may be non-corrosive and resistant to high temperatures. In some embodiments, the electrodes comprise Inconel. Inconel is advantageous as it is highly conductive.

In some embodiments, the graphene production system includes polytetrafluoroethylene (PTFE). In some embodiments, the graphene production system includes a PTFE-lined chamber. In some embodiments, the graphene production system includes PTFE-lined carbon steel tubing, e.g., PTFE-lined carbon steel schedule 40 tubing. PTFE is advantageous in that it is a non-corrosive material that may withstand high temperatures and pressures.

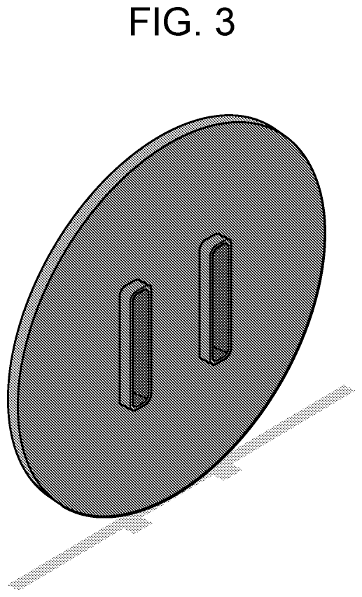

The chamber may comprise seals. In some embodiments, the seals include silicon, e.g. mica silicon composite. Mica silicon composite is advantageous in that it provides high heat durability and a tight seal under high pressures. FIG. 3 depicts one embodiment of a seal for use with the chamber of FIGS. 1A, 1B, and 1C.

Graphene, once produced, is prepared in a variety of methods for the manufacture of secondary products. Preparation strategies include solution compounding, melt blending, in situ polymerization, and layer by layer assembling, for example. The graphene disclosed herein is advantageous in that it does not require post-processing (e.g., purification) before preparation for secondary use. By producing graphene from a high-purity solid carbon source, post processing steps commonly required in the manufacture of graphene are avoided. In some embodiments, the graphene may be mixed with a binding agent (e.g., a polymer solution) or dispersion liquid to form a mixture without a prior purification step. In some embodiments, the binding agent is a polymer solution. The graphene may be present in the mixture between 0.1% and 99.99% (w/w) (e.g., between 0.1% and 1% (w/w), 1% and 5% (w/w), 5% and 10% (w/w), 10% and 25% (w/w), 25% and 50% (w/w), 50% and 75% (w/w), or 90% and 99.99% (w/w)). In some embodiments, the graphene may be present in the mixture in greater than 90% (w/w) (e.g., greater than 91% (w/w), 92% (w/w), 93% (w/w), 94% (w/w), 95% (w/w), 96% (w/w), 97% (w/w), 98% (w/w), or 99% (w/w)).

### EXAMPLES

The following examples are put forth so as to provide those of ordinary skill in the art with a complete disclosure and description of how the methods and compounds claimed herein are performed, made, and evaluated, and are intended to be purely exemplary of the invention and are not intended to limit the scope of what the inventors regard as their invention.

### Example 1: Production of High-Quality Graphene

A stoichiometric mixture of carbon dioxide and hydrogen gas are added to a first chamber according to the Bosch Reaction. The chamber is heated to 600° C. and pressurized with argon gas. After an hour the chamber is purged with argon and the resulting solid carbon transferred to a second chamber. The solid carbon is deposited between two electrodes connected to a plurality of capacitors operable for applying a voltage pulse. A voltage pulse having a duration of 10 milliseconds and a voltage between 100 V and 400 V is applied to the solid carbon producing a high-purity graphene.

What is claimed is:

1. A method of producing graphene, the method comprising:
a. providing a high-purity solid carbon source, wherein the solid carbon source is greater than 99.99% (w/w) elemental carbon; and
b. applying a voltage pulse across the solid carbon source to convert the solid carbon source into graphene, wherein the graphene comprises less than 200 ppm extrinsic defects.

2. The method of claim 1, wherein the solid carbon source is greater than 99.995% (w/w) elemental carbon.

3. The method of claim 1, wherein the solid carbon source is greater than 99.999% (w/w) elemental carbon.

4. The method of claim 1, wherein the solid carbon source is greater than 99.9995% (w/w) elemental carbon.

5. The method of claim 1, wherein the solid carbon source is greater than 99.9999% (w/w) elemental carbon.

6. The method of any one of claims 1 to 5, wherein the graphene comprises less than 100 ppm extrinsic defects.

7. The method of any one of claims 1 to 5, wherein the graphene comprises less than 50 ppm extrinsic defects.

8. The method of any one of claims 1 to 5, wherein the graphene comprises less than 25 ppm extrinsic defects.

9. The method of any one of claims 1 to 5, wherein the graphene comprises less than 10 ppm extrinsic defects.

10. The method of any one of claims 1 to 5, wherein the graphene comprises less than 5 ppm extrinsic defects.

11. The method of any one of claims 1 to 10, wherein the graphene comprises less than 1 ppm extrinsic defects.

12. The method of any one of claims 1 to 11, wherein the extrinsic defects are assessed by Raman spectroscopy, x-ray photoelectron spectroscopy (XPS), inductively coupled plasma optical emission spectroscopy (ICP-OES), ICP-mass spectroscopy (ICP-MS), proton induced x-ray emission, x-ray diffraction (XRD), transmission electron microscopy (TEM), scanning electron microscopy (SEM), scanning tunnelling microscopy (STM), atomic force microscopy (AFM), energy dispersive x-ray analysis (EDX), oxidative combustion, and/or thermo gravimetric analysis.

13. The method of any one of claims 1 to 12, wherein the extrinsic defect is oxygen.

14. The method of claim 13, wherein the graphene comprises less than 200 ppm oxygen.

15. The method of any one of claims 1 to 14, wherein the graphene comprises less than 0.01% intrinsic defects.

16. The method of any one of claims 1 to 15, wherein the intrinsic defects comprise non-sp² orbital hybrid carbon atoms.

17. The method of any one of claims 1 to 16, wherein the graphene comprises less than 0.01% sp³.

18. The method of any one of claims 1 to 17, wherein percent sp² of the graphene is at least 95%.

19. The method of any one of claims 1 to 18, wherein the graphene has a I(D)/I(G) ratio of less than 0.2, as measured by Raman spectroscopy.

20. The method of any one of claims 1 to 19, wherein the graphene has a I(2D)/I(G) ratio of between 0.5 and 2, as measured by Raman spectroscopy.

21. The method of any one of claims 1 to 20, wherein the electrical conductivity of the graphene is at least 104 S/m.

22. The method of any one of claims 1 to 21, wherein the specific surface area (SSA) of the graphene is greater than 1000 m²/g.

23. The method of any one of claims 1 to 22, wherein the graphene is graphene flakes, and wherein the graphene flakes have an average lateral size (D50) of at least 10 μm.

24. The method of any one of claims 1 to 23, wherein the graphene is not purified following step b).

25. The method of any one of claims 1 to 24, wherein extrinsic defects are not removed following step b).

26. The method of any one of claims 1 to 25, wherein the solid carbon source comprises greater than 90% (w/w) amorphous carbon.

27. The method of any one of claims 1 to 25, wherein the solid carbon source comprises greater than 90% (w/w) graphite carbon.

28. The method of any one of claims 1 to 27, wherein the solid carbon source is generated by reduction of carbon dioxide or carbon monoxide with hydrogen gas.

29. The method of any one of claims 1 to 27, wherein the solid carbon source is produced from carbon dioxide and hydrogen gas via a Bosch reaction.

30. The method of any one of claims 1 to 28, wherein the hydrogen gas is provided an amount greater than the stoichiometric ratio required for a reduction of the carbon dioxide or carbon monoxide.

31. The method of any one of claims 1 to 27, wherein the solid carbon source is produced from carbon monoxide via a Boudouard reaction.

32. The method of any of claims 29 to 31, wherein the reaction comprises a catalyst or catalyst pre-cursor.

33. The method of any of claims 29 to 32, wherein the reaction occurs at room temperature.

34. The method of any of claims 29 to 33, wherein the reaction occurs at temperatures between 450° C. to 2000° C.

35. The method of any one of claims 1 to 34, wherein step b) is conducted under atmospheric pressure.

36. The method of any one of claims 1 to 35, wherein the method produces at least one gram of graphene.

37. The method of any one of claims 1 to 36, wherein the yield of graphene from the solid carbon source is at least 90%.

38. The method of any one of claims 1 to 37, wherein the method further comprises the step of c) mixing the graphene with a binding agent or dispersing agent without further purification.
